(19) United States
(12) Patent Application Publication
(10) Pub. No.: US 2006/0118728 A1
(43) Pub. Date: Jun. 8, 2006

(54) Wafer bonded silicon radiation detectors

(76) Inventors: Bernard Phlips, Accokeek, MD (US); Francis J. Kub, Arnold, MD (US); Karl D. Hobart, Upper Marlboro, MD (US); James D. Kurfess, Gambrills, MD (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 11/258,464

(22) Filed: Oct. 25, 2005

Related U.S. Application Data
(60) Provisional application No. 60/635,192, filed on Dec. 3, 2004.

(51) Int. Cl. G01T 1/24

(52) U.S. Cl. 250/370.01

(57) ABSTRACT

An apparatus and method for operating a direct wafer bonded semiconductor radiation detector includes bonding a plurality of wafers, receiving a radiation signal from a radiation source thereby producing electron and hole pairs via the radiation signal interacting with the detecting device. A voltage source produces a voltage across the direct bonded wafers, thereby drifting the electrons and holes through the plurality of bonded layers. The drifted electrons and/or holes include total drifted charge information of the detector and are collected and processed either at the detector or remote from the detector.

### CROSS-REFERENCE TO RELATED APPLICATIONS

This application claims benefit under 35 U.S.C. § 119(e) of a provisional U.S. patent application of Phlips et al entitled “Wafer Bonded Silicon Radiation Detectors”, Ser. No. 60/635,192, filed Dec. 3, 2004, the entire contents of the provisional application being incorporated herein by reference.

### BACKGROUND OF THE INVENTION

1. Field of the Invention

The present invention relates generally to radiation detectors. More specifically the present invention relates to thick, high resistivity semiconductor radiation detectors formed through low temperature direct wafer bonding.

2. Description of Related Art

Semiconductor detectors are based on crystalline semiconductor materials, most notably silicon and germanium. High-resolution x-ray and gamma ray detection preferably employ germanium and silicon detectors as the preferred detector technology. Germanium detectors in particular have been preferred due to their outstanding energy resolution and high efficiency in the gamma ray energy range, e.g., approximately 30 keV-3000 keV. In addition, silicon detectors have been preferred in the X-ray range of approximately 0.5 keV-15 keV.

Conventional high-energy particle detectors have been manufactured from wafers of silicon. Typically, these detectors have a strip pattern on the surface to provide positional information of the particle source under detection. For two-dimensional information, double-sided detectors employ orthogonal strip patterns on opposite surfaces of the wafer, as well as pixels on a single sided detector. However, manufacturing double-sided detectors is more expensive than conventional wafer processing techniques that are designed for single-sided wafer processing.

In a variety of applications, for example nuclear medical imaging, radiography, and special nuclear materials the development and fabrication of thick silicon semiconductor detectors are desired. High-resistivity intrinsic semiconductor detectors are desirable in order to achieve thicker detectors. High resistivity can be used to perform detection at lower operating voltages or with thicker detectors, since resistivity and operating voltages are inversely proportional. Currently, high resistivity intrinsic silicon semiconductor detectors are commercially available at a thickness of approximately 2 mm. However, it is difficult to operate intrinsic detectors (with typical resistivities of 20,000 ohm-cm) with thicknesses greater than 2-3 mm due to well-known problems associated with high voltage break down. These problems are a result of the voltage required to achieve full depletion, which varies as the square of the thickness.

Conventionally, thicker detectors can be developed using a lithium-drifted process by depositing lithium across the semiconductor, for example, placing a voltage across the detector and allowing the lithium to drift through the semiconductor to make a crystal of higher resistivity. However, this method has significant drawbacks in that it is time consuming and expensive to drift thick Si(Li) detectors, taking several months to drift a detector that is 1 cm thick. Furthermore, these Si(Li) detectors typically have to be operated cold (approximately −50° C.) and are very susceptible to higher leakage currents following vacuum and temperature changes. Additionally the detectors do not use standard CMOS or non-CMOS technology. Accordingly, a crystal that is converted to higher resistivity to achieve the desired level of thickness still has significant drawbacks.

In addition to the issue of thickness, a disadvantage of germanium detectors is the liquid nitrogen temperature requirement for operation.

Accordingly, a need exists for a silicon radiation detector employing low temperature direct wafer bonding technology in a variety of thicknesses.

### BRIEF SUMMARY OF THE INVENTION

The present invention preferably provides a method for detecting radiation from a radiation source via a direct wafer bonded semiconductor radiation detector.

One object of the present invention is to provide a method for detecting radiation via a detector apparatus with a pixilated first side and an un-pixilated second side in order to determine the amount of charge detected by the detector.

An additional object of the present invention is to provide a method for detecting radiation via a radiation detector apparatus with strip detectors on the first and second side of the detector, as well as strip detectors on just one side of the detector. The strip or pixel location allows the detector to form the image.

A still further object of the present invention is to direct wafer bond at least one crystal between the first and second sides of the radiation detector.

These and other objects are achieved by a method for detecting radiation comprising bonding a plurality of layers to detect radiation from a source, the bonded layers form a detecting device including a first side and a second side of the detecting device, receiving a radiation signal from a radiation source at the detecting device thereby producing electrons and holes via the radiation signal interacting with the detecting device, and applying a voltage across the detecting device, thereby drifting the electrons and holes through at least one of the plurality of bonded layers to one of the first side and the second side, the drifted electrons and holes include total drifted charge information of the detector, and collecting and processing the total drifted charge information at the one of the first side and the second side of the detecting device.

### BRIEF DESCRIPTION OF THE DRAWINGS

These and other objects, advantages and novel features of the invention will be more readily appreciated from the following detailed description when read in conjunction with the accompanying drawings, in which:

FIG. 1(a) illustrates two semiconductor wafers bonded together employing the direct wafer bonded process;

FIG. 11(b) illustrates a device with three semiconductor wafers bonded together wherein the device does not employ the direct wafer bonded process;

FIG. 2(a) illustrates a direct wafer bonded radiation detector including three semiconductor wafers employing the direct wafer bonded process constructed in accordance with an embodiment of the present invention;

FIG. 2(b) illustrates a direct wafer bonded radiation detector employing two single sided detectors and a plurality of thick, high resistivity wafers wherein the wafers are bonded together employing the direct wafer bonding process in accordance with an embodiment of the present invention;

FIG. 3 depicts a graph representing the number of x-ray counts detected as a function of energy for the 59.5 keV emission from an Americium-241 source when measured with the direct wafer bonded radiation detector constructed in accordance with an embodiment of the present invention;

FIG. 4 depicts a graph representing the number of x-ray counts detected as a function of energy for the 122 keV emission from a Cobalt-57 source when measured by the low temperature direct wafer bonded radiation detector constructed in accordance with an embodiment of the present invention.

FIG. 5 illustrates a thick X-ray pixel radiation detector, wherein each pixel is bump-bonded to a plurality of electronic readout apparatus disposed on a separate wafer, the detector constructed according to an embodiment of the present invention;

FIG. 6 illustrates a double sided strip radiation detector, wherein the signaling information from the detector is readout at the end of each strip to electronic readout apparatus, the detector constructed in accordance with an embodiment of the present invention;

FIG. 7 illustrates a thick strip detector constructed in accordance with an embodiment of the present invention; and

FIG. 8 illustrates a thick radiation detector with large and active pixels on one side of the detector and fine pixels on the opposite or second side of the detector constructed in accordance with an embodiment of the present invention.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

Thin position-sensitive solid-state detectors have been extensively used over the last two decades. For applications involving thicker detectors, thin CMOS or non-CMOS semiconductor wafers are bonded directly to each other, or are bonded to opposite sides of an intervening thick high-resistivity semiconductor wafer, using a direct wafer bonding process (described below). It is important to note that the detector can employ CMOS semiconductor wafers that are readily available and inexpensive or non-CMOS wafers. This process produces a detector for particle detection and for high spectral resolution, high efficiency x-ray and gamma ray detectors. Such detectors have several advantages over currently available technology. Double-sided detectors can be manufactured using only single-sided CMOS or non-CMOS processes on the electron and hole collection wafers, thereby simplifying the manufacturing process significantly. Detectors using a thick high-resistivity (e.g. 20,000-100,000 ohm-cm compared to 10,000-20,000 ohm-cm) intervening semiconductor wafer or a plurality of wafers can be operated at lower maximum voltages since the voltage required scales as the inverse of the resisitivity. The intervening thick (e.g., greater than approximately 2 mm.) semiconductor wafer enables the fabrication of more efficient, lower cost detectors. In addition, use of position-sensitive CMOS or non-CMOS devices, such as CCDs (Charge Coupled Devices) and APDs (active pixel devices), enable tracking of the electrons in the thick semiconductor detectors. With this new technology several improvements and important new applications are available for these position-sensitive solid-state detectors. These include x-ray timing and imaging, medical imaging, polarization measurements, and high-resolution, high-sensitivity gamma-ray imaging (e.g. for homeland defense). As discussed later, substantial cost savings are anticipated with use of the low temperature direct wafer bonded semiconductor detectors.

A direct wafer bonding process, as described in a U.S. Pat. No. 6,194,290 and herein incorporated by reference, is employed in the present invention. Low temperature direct wafer bonding is an enabling technology that allows fabrication of a variety of complicated structures that typically would be difficult or impossible to bond by other methods. Thus, low temperature direct semiconductor wafer bonding is a method of combining two or more substrates without an intermediate material layer or requiring electric charge manipulation as in anodic bonding, for example.

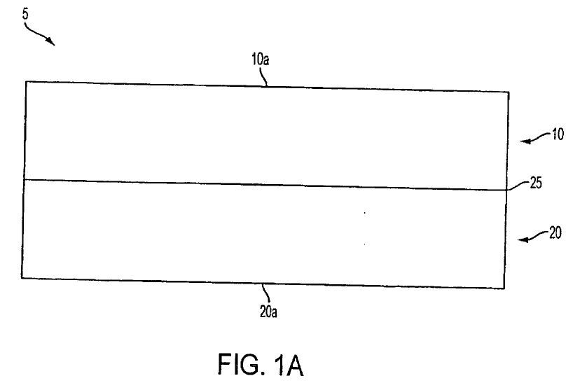

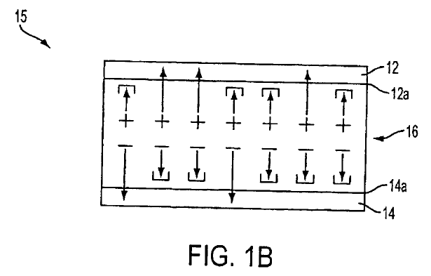

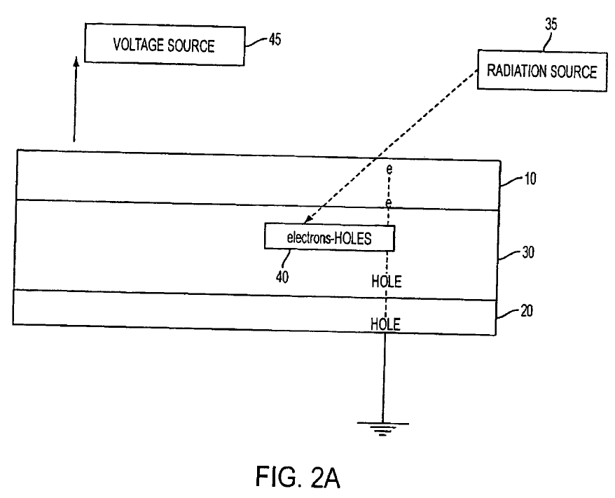

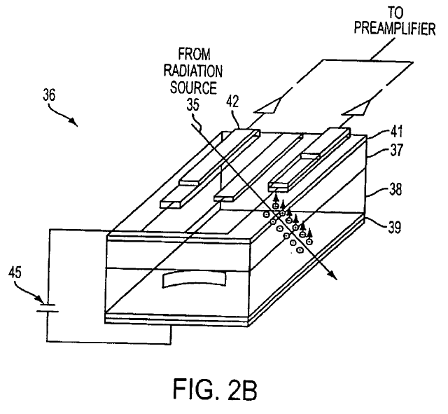

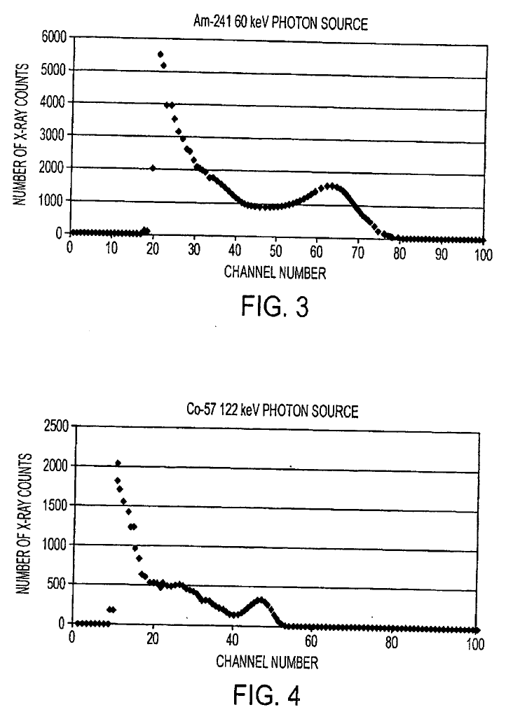

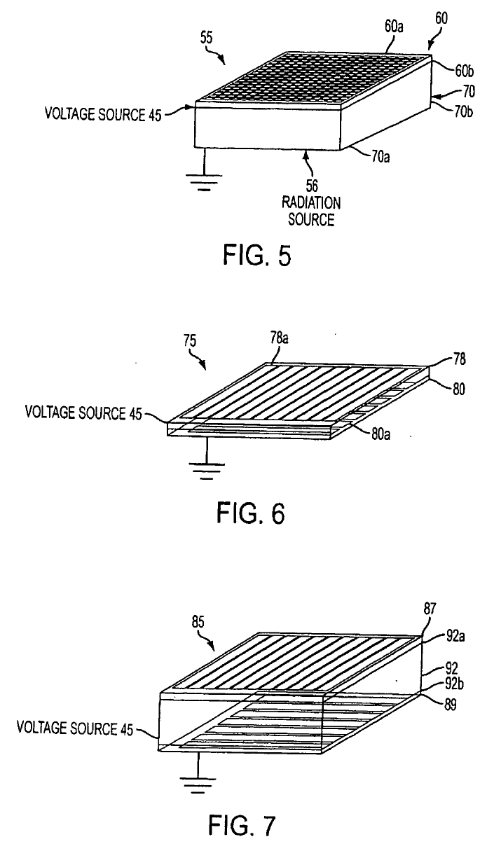

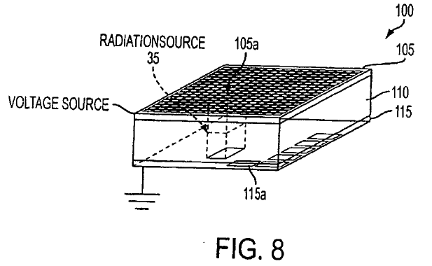

The process is briefly described as follows: Specifically, FIG. 1(a) illustrates the planar surfaces of device 5 including semiconductor wafers 10 and 20. The wafers are ground and polished to achieve very flat surfaces with typical surface roughness of just a few angstroms, for example. The two flat surfaces of wafers 10 and 20 are placed in contact to form a strong bond at the interface 25 that has characteristics of the native materials. Annealing up to about 400° C. provides a very strong interface, and does not adversely affect the processed surface. Alternative processing steps include gettering, for example, to remove impurities, plasma etching, and ion implantation to provide desired semiconductor characteristics, etching for oxide removal, and addition of small grooves to enable gases at the interface 25 to escape.

The above-described direct wafer bonding process enables electrons and/or holes created within the semiconductor wafers 10 and 20 to be drifted through the semiconductor wafers including drfting through the interface 25 and collected at surfaces 10a and 20a of the wafers 10 and 20. As readily apparent to one skilled in the art, some energy is shared by the electrons of a detector's crystal. Upon external excitation, electrons in a valence band of the crystal gain sufficient energy to cross into a conduction band forming a cloud or track in the crystal. This excitation process not only creates electrons in the conduction band, but also creates holes in the valence band thereby facilitating the process of detection.

One of ordinary skill in the art would recognize the great difficulty of electrons passing through interface 25 to the surfaces 10a or 20a, depending upon the polarity applied to the semiconductor wafers, as described below. Losing any electrons in the structure 5 would degrade the energy resolution from the detector to such a point as to make spectroscopy unpracticable.

Accordingly, to obtain quality charge collection, conventional thinking has always been to employ a single crystal in any type of radiation detector. Moreover, any impurities between interface 25 would produce a plurality of impurities and alignment points that are askew thereby prohibiting crossing of the electrons to the upper surface 10a. In addition, the process of creating a high resistivity semiconductor wafer requires exposing the wafer to high temperatures (e.g., >1000° C.) thus causing impurities to further limit the electron flow within the detector 5.

FIG. 1(b) illustrates the conventionally observed phenomena of electron clouds or tracks not drifting through interfaces between wafers. This concept is depicted via structure 15 employing three wafers 12,14, and 16. Wafer 16 is a thick wafer, on the order of 2 mm or more, that is not direct wafer bonded to the wafers 12 and 14 as detailed in the direct wafer bonding process above. Accordingly, as shown all of the electrons and holes cannot drift through the interfaces 12a and 14a. This well known concept is detailed in “Radiation Detection Measurement” by Glenn F. Knoll.

However, the present invention employs a unique direct wafer bonding process, described above that is able to facilitate the drifting of electrons through a plurality of layers. This process is further amenable to the fabrication of semiconductor radiation detectors that allow substantially complete electron cloud drift throughout a plurality of wafers. FIG. 2(a) illustrates a simple schematic of the direct wafer bonded detector. In this process, two single-sided wafers, for examples wafers 10 and 20, are bonded together to make a thin detector 5, or if a thicker detector is desired, such as in FIG. 2(a), one or more high resistivity thick wafers of semiconductor 30 are wafer bonded, via the direct wafer bonding process, between two single-sided standard CMOS or non-CMOS detector technology wafers 10 and 20. The thick wafer 30 is on the order of 2 mm. or more. X-rays or gamma rays from a radiation source 35 strike the thick high resistivity semiconductor wafers 10, 20, and 30. Electron-hole pairs 40 are created in one or more of the wafers, however, for simplicity one strike is shown to the high resistivity thick semiconductor wafer 30, for example. Upon application of a voltage, via voltage source 45, the electrons and holes are drifted through the thick high resistivity semiconductor wafer 30 and collected in the CMOS or non-CMOS processed wafers 10 and 20 bonded onto either side of the thick high resistivity wafer. The thickness of the high resistivity wafer ranges from approximately 2 mm-7 mm thick. The high resistivity semiconductor wafers are direct wafer bonded between two approximately 0.5 mm thick CMOS or non-CMOS processed wafers.

The front side of semiconductor wafer 10 and the backside semiconductor of wafer 20 are fabricated using normal processing procedures and temperatures. Thick high resistivity semiconductor wafers are available with 50,000-100,000 ohm-cm resistivity, and a thickness on the order of 2 mm to 3 centimeters or more approximately. This high resistivity enables a thick depletion region to form allowing the voltage from voltage source 45 to drop over the distance defined by the thickness of the high resistivity semiconductor wafer 30.

However, high temperature processing can decrease the resistivity of high resistivity semiconductor. High temperature processing can also reduce the minority carrier recombination lifetime and thus decrease the minority carrier diffusion length. The low temperature (approximately 400°-600° C.) direct wafer bonding process of U.S. Pat. No. 6,194,290 enables fabrication of particle, X-ray and gamma-ray detectors by direct wafer bonding at least one high resistivity semiconductor wafer in between the hole collecting semiconductor wafer 20 and the electron collecting semiconductor wafer 10. Accordingly, when wafer 30 is direct wafer bonded to the wafers 10 and 20, the wafer 30 takes on the characteristics of a single crystal with no impurities, despite the fact that wafer bonding has taken place.

FIG. 2(b) illustrates the drifting of the electrons and holes in silicon detector 36 employing two thick high resistivity layers 37 and 38. In addition, detector 36 employs two thin layers 39 and 41 disposed at opposite sides of the detector. All of the layers have been bonded together via the low temperature direct wafer bonding process described above.

In operation, a voltage is applied to the detector via voltage source 45. A radiation source 35 directs energy towards the detector 36 and excites the electron-hole pairs within the detector. The electrons and holes separate and drift through the two thick resistivity layers 37 and 38, respectively. In addition, the electrons and holes are further able to drift through layers 41 and 39 as if layers 41, 39, 37, and 38 were a single crystal. This drifting is achieved due to the layers being low temperature direct wafer bonded together. The total drifted charge information relating to the electrons is detected at the strip detectors 42 disposed on the top of layer 41. The information is further processed via preamplifiers (not shown) located remote from detector 36.

FIGS. 3 and 4 illustrate low energy gamma ray spectra acquired with a 2 mm thick high resistivity semiconductor wafer that is low temperature direct wafer bonded between two 0.25 mm CMOS or non-CMOS semiconductor devices. FIG. 3 employs a radiation source comprising Americium-241 and depicts the x-ray counts detected as a function of energy for a 59.5 keV emission when measured with the direct wafer bonded silicon detector. FIG. 4 employs a radiation source comprising Cobalt-57 and depicts the x-ray counts detected as a function of energy for a 122 keV emission when measured with the direct wafer bonded silicon detector. The spectra for FIGS. 3 and 4 were acquired using the direct wafer bonded silicon detector coupled to a preamplifier (not shown), followed by a shaping amplifier (not shown). The signals from the amplifier were collected in a Multi-Channel Analyzer (MCA), to histogram the distribution of signal amplitudes. The X-axis of both FIGS. 3 and 4 are measured energy deposited, and the y-axis of both FIGS. 3 and 4 are the number of events detected at specified energy levels. The peak on the right hand side of FIG. 3 is generated by 59.5 keV photons depositing all their energy in the device. Similarly, the peak on the right hand side of FIG. 4 is generated by 122 keV photons that deposited all their energy in the direct wafer bonded silicon radiation detector. The continuum to the left of the peaks is due to events where only part of the energy was deposited in the direct wafer bonded silicon radiation detector.

The direct wafer bonded silicon radiation detector as described above can be employed in a plurality of embodiments as will now be described. A first embodiment is illustrated in FIG. 5 illustrating a pixellated CMOS or non-CMOS detector 55. The detector is comprised of a pixellated top portion 60a disposed on wafer 60, which is direct wafer bonded to wafer 70 which is a thick, high resistivity semiconductor wafer.

In operation, a radiation source 56 emits a particle, gamma ray or x-ray, or other ionizing particles for example, at the under portion 70a of detector 55. The interaction of the emitted radiation and the voltage causes electron-hole pairs to be formed within detector 55. A voltage is applied to the detector 55, via voltage source 45. The electrons are then drifted to a first side 60b of wafer 60 through the pixellated surface 60a of wafer 60. By contrast, the holes are drifted to a second side 70b of wafer 70. The drifting of the electrons and holes can be reversed depending upon the polarity of the detector 55. The drifted electrons include total drifted charge information that is processed via the individual pixels of wafer 60. The individual pixels can be bump bonded to electronic readout on separate wafers. In addition to being processed onboard the wafer 55, the processing can also be done remote to wafer 55. Due to low leakage current and small capacitance of the small pixels (e.g., 2 mm×2 mm), the detector 55 provides excellent energy resolution and position resolution in the tens of keV energy range. The applications of this type of detector are in such areas as X-ray navigation, NASA timing missions, medical imaging, and industrial radiography.

A second embodiment is depicted FIG. 6. This embodiment includes a double-sided strip surface on detector 75. The detector includes two relatively thin CMOS or non-CMOS device wafers 78 and 80 bonded together via the direct wafer bonding method mentioned above. The upper surface of wafer 78 comprises a plurality of conventional strip detectors 78a and is coupled to voltage source 45, and the lower portion of wafer 80 also comprises a plurality of strip detectors 80a. The strips 78a and 80a are positioned in an orthogonal pattern. Detector 75 preferably provides position-sensitive measurements employing strip detectors 78a and 80a for hard X-rays or penetrating particles, but with fewer readout channels required compared to the detector in FIG. 4.

The operation of detector 75 is similar to that of the detector 55 of FIG. 5. However, detector 75 employs strip detectors 78a and 80a, in a conventional fashion, in order to determine position information of the total drifted charge information as a result of radiation being directed towards the detector.

A third embodiment depicted in FIG. 7. This device is a double-sided strip detector 85 made from two relatively thin CMOS or non-CMOS wafers 87, 89 direct wafer bonded on to a first side 92a and a second side 92b of a thick, high resisitivity semiconductor wafer 92. Conventionally, electrons would not be expected to diffuse through an interface of a thick high resistivity semiconductor wafer that has been bonded to another wafer. However, due to the unique properties of the wafer bonding process, electrons are able to diffuse through interfaces bonded through this process.

In operation, a gamma ray (not shown) is directed toward detector 85, a voltage, via voltage source 45 is applied to one of the thin CMOS or non-CMOS wafers 87 and 89. Electrons are drifted towards the direction of a surface of one of the wafers 87 and 89, whereas holes are drifted to the opposite directions of the electrons. The strip detectors on the surface of wafers 87 and 89 are then able to determine the location of the associated total drifted charge information with the incident radiation.

These type of detectors have excellent sensitivity to charged particles and higher energy X-rays (e.g. 3-1000 keV) and are a preferred candidate for Compton gamma ray imaging where an incident gamma ray interacts at two or more locations in one or more detectors. This multiple Compton scatter technique enables the energy and direction cone of a gamma ray to be determined without the full energy of the gamma ray being absorbed. This provides improved sensitivity and imaging and is a leading candidate for gamma ray astronomy, and for homeland defense applications. In addition, this type of detector provides significant cost savings.

In addition to employing strip detector positioning devices such as active pixel sensors (APS) can be direct wafer bonded to a thick high resistivity semiconductor wafer. The APS is similar to a charge coupled device (CCD), but individual pixels can be read out giving the devices greater operational flexibility. This is similar to the embodiment shown in FIG. 5, but with the use of an Active Pixel Sensor, each pixel can be read out separately, and the pixel size (typical 20-100 microns) results in excellent energy resolution and position, limited only by the number of electrons produced by initial gamma ray, for example. In addition, each pixel can have electronics associated with the individual pixels on board the wafer.

A final embodiment is depicted in FIG. 9. The detector 100 includes an Active Pixel Detector wafer 105 direct wafer bonded to one side of a high resistivity wafer 110. This high resistivity wafer 110 is direct wafer bonded to a pixellated CMOS or non-CMOS device wafer 115 on the opposite side of the high resisitivity wafer 110. In operation, this detector 100 enables the tracking of electrons to be measured within individual detectors. Holes or electrons collected on the large area pixels 115a on the bottom side of the detector 100 trigger the readout of pixels 105a on the opposite face of APS wafer 105. The track of electrons greater than several hundred keV can be measured as shown. This will have significant advantages for many applications. For example, measuring the track of electrons in a Compton scatter imaging gamma ray detector will dramatically improve the sensitivity through background reduction and restricting the direction of the incoming gamma ray to a small segment of the Compton cone.

Large area, high-resisitivity semiconductor wafers up to 150 mm-200 mm diameter are available. Thin CMOS or non-CMOS pixellated and strip detectors, as well as APS sensors in these sizes are also available. Therefore, the wafer bonding technique enables a variety of thick, large area detectors for various applications.

Several alternatives can be used for the high resistivity semiconductor wafers. These include high-resistivity, intrinsic wafers, nuclear transmutation doped (NTD) wafers.

This wafer bonding technology can be applied to other semiconductor radiation detectors such as germanium, silicon carbide, silicon nitride, cadmium-zinc-telluride, cadmium telluride, and gallium arsenide.

Although only several exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A method comprising:
bonding a plurality of layers to detect radiation from a source, the bonded layers form a detecting device including a first side and a second side of the detecting device;
receiving a radiation signal from a radiation source at the detecting device thereby producing electrons and holes via the radiation signal interacting with the detecting device;
applying a voltage across the detecting device, thereby drifting the electrons and holes through at least one of the plurality of bonded layers to one of the first side and the second side, the drifted electrons and holes include total drifted charge information of the detector; and
collecting and processing the total drifted charge information at the one of the first side and the second side of the detecting device.

2. The method of claim 1, wherein said bonding the plurality of layers includes direct wafer bonding.

3. The method of claim 1, wherein said receiving the radiation signal includes receiving gamma rays, X-rays, and ionizing particles.

4. The method of claim 1, wherein said receiving includes receiving the radiation signal through a pixilated surface disposed on the one of the first side and the second side of the detecting device.

5. The method of claim 1, further comprising:
electrically grounding the one of the first side and the second side of said detecting device.

6. The method of claim 1, wherein said bonding includes bonding at least one crystal layer to the detecting device.

7. The method of claim 6, wherein said bonding includes bonding the at least one crystal layer between the first side and the second side of the detecting device.

8. The method of claim 1, wherein said receiving further comprises receiving the radiation signal through a plurality of pixels disposed on the first side of the detecting device.

9. The method of 1, wherein said collecting and processing the total drifted charge information further comprises determining a location of the total drifted charge information via said plurality of pixels.

10. The method of claim 1, wherein said collecting and processing the charge information further comprises coupling the plurality of pixels to preamplifiers, wherein the preamplifiers are remote from the detecting device.

11. The method of claim 1, wherein said receiving the radiation signal further comprises receiving the radiation signal through a plurality of strip detectors disposed on the first side of the detecting device.

12. The method of claim 1, wherein said said receiving the radiation signal further comprises receiving the radiation signal through a plurality of strip detectors disposed on the second side of the detecting device.

13. The method of claim 1, said collecting and processing further comprises processing the total drifted charge information remote from the detecting device.

14. The method of claim 1, said collecting and processing further comprises processing the total drifted charge information at the detecting device.

15. An apparatus for detecting radiation, said apparatus comprising:
a radiation source;
a plurality of wafers bonded via direct wafer bonding to form a radiation detector, wherein said detector includes a first side and a second side;
an energy source electrically coupled to the plurality of wafers, said radiation source operable to emit radiation energy towards said plurality of wafers thereby producing electrons and holes via an interaction of the radiation energy and said plurality of wafers, and wherein said energy source operable to drift the electrons and holes to the first side and the second side of the radiation detector; and
a processing device coupled to said plurality of wafers operable to process signal information associated with the drifted electrons and holes.

16. The apparatus of claim 15, further comprising at least one crystal layer being direct wafer bonded to the plurality of bonded wafers of the radiation detector.

17. The apparatus of claim 15, wherein said signal information includes total drifted charge information.

18. The apparatus of claim 15, further comprising:
a plurality of pixels disposed on one of the first side and the second side of the detector operable to determine total drifted charge information associated with the drifted electrons and holes.

19. The apparatus of claim 15, further comprising:
a plurality of strip detectors disposed on one of the first side and the second side of the detector operable to determine total drifted charge information of the drifted electrons and holes.

20. The apparatus of claim 16, wherein said crystal layer being said direct wafer bonded and disposed between the first side and the second side of said detector.
